(19) United States
(12) Patent Application Publication
(10) Pub. No.: US 2026/0203274 A1
(43) Pub. Date: Jul. 16, 2026

(54) CONTEXT-BASED RESPONSE FORMULATION FOR RETRIEVAL-AUGMENTED GENERATION SYSTEMS

(71) Applicant: Dell Products L.P., Round Rock, TX (US)

(72) Inventors: Shibi Panikkar, Bangalore (IN); Susana Cherian, Trivandrum (IN)

(21) Appl. No.: 19/016,452

(22) Filed: Jan. 10, 2025

(51) Int. Cl. G06F 16/23

(52) U.S. Cl. CPC G06F 16/2365

(57) ABSTRACT

The subject technology relates to context-based response formulation for retrieval-augmented generation systems. An example method facilitating context-based response formulation for retrieval-augmented generation systems includes supplementing a query provided to a machine learning model with supplemental entity data, resulting in an augmented query, where the supplemental entity data is determined based on context information associated with the query and expected entity types associated with a determined intent of the query. The method can further include determining an estimated degree of error associated with a document retrieved by the machine learning model in response to the augmented query, and facilitating, in response to the estimated degree of error being lower than a threshold degree of error, generating a response to the query based on the document.

### BACKGROUND

Retrieval-augmented generation (RAG) is a technique that can improve responses provided by a large language model (LLM) or other machine learning model by augmenting a model-produced response with information retrieved from a document or other external information source. RAG architectures can be of particular use to corporations or other entities that utilize LLM-based applications but lack the resources to fine tune an off-the-shelf LLM or build their own LLM. In an RAG system, the accuracy of provided responses can be dependent on the embedded document provided to an associated LLM alongside a user query, e.g., in terms of the content or context provided by the embedded document.

### SUMMARY

The following summary is a general overview of various embodiments disclosed herein and is not intended to be exhaustive or limiting upon the disclosed embodiments. Embodiments are better understood upon consideration of the detailed description below in conjunction with the accompanying drawings and claims.

In an implementation, a system is described herein. The system can include at least one processor and at least one memory that stores executable instructions that, when executed by the at least one processor, facilitate performance of operations. The operations can include augmenting a query provided to a retrieval-augmented generation (RAG) system with supplemental entity data, resulting in an augmented query. The supplemental entity data can be determined based on context information associated with the query and expected entity types associated with a determined intent of the query. The operations can further include estimating a degree of error associated with a document retrieved by the RAG system in response to the augmented query. The operations can additionally include, in response to the degree of error associated with the document being determined to be lower than a threshold degree of error, generating a response to the query based on the document.

In another implementation, a method is described herein. The method can include supplementing, by a system including at least one processor, a query provided to a machine learning (ML) model with supplemental entity data, resulting in an augmented query. The supplemental entity data can be determined based on context information associated with the query and expected entity types associated with a determined intent of the query. The method can also include determining, by the system, an estimated degree of error associated with a document retrieved by the ML model in response to the augmented query. The method can further include facilitating, by the system and in response to the estimated degree of error being lower than a threshold degree of error, generating a response to the query based on the document.

In an additional implementation, a non-transitory machine-readable medium is described herein that can include instructions that, when executed by at least one processor, facilitate performance of operations. The operations can include augmenting a query provided to an RAG system with supplemental entity data, resulting in an augmented query, where the supplemental entity data is generated based on context information associated with the query and expected entity types associated with a determined type of the query; estimating a degree of error associated with a document retrieved by the RAG system in response to the augmented query; and generating, in response to the degree of error being determined to be lower than a threshold degree of error, a response to the query based on the document.

### DESCRIPTION OF DRAWINGS

Various non-limiting embodiments of the subject disclosure are described with reference to the following figures, wherein like reference numerals refer to like parts throughout unless otherwise specified.

FIG. 1 is a block diagram of a system that facilitates context-based response formulation for retrieval-augmented generation (RAG) systems in accordance with various implementations described herein.

FIGS. 2-3 are diagrams illustrating respective RAG system frameworks in which various implementations described herein can function.

FIGS. 4-9 are block diagrams of additional systems that facilitate context-based response formulation for RAG systems in accordance with various implementations described herein.

FIGS. 10-11 are flow diagrams of respective methods that facilitate context-based response formulation for RAG systems in accordance with various implementations described herein.

FIG. 12 is a diagram of an example computing environment in which various implementations described herein can function.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring subject matter.

Various implementations described herein relate to techniques for ensuring accurate and contextually relevant responses from a large language model (LLM) operating in a retrieval-augmented generation (RAG) system. While some implementations described herein relate to a use case involving a customer support chatbot that provides assistance in troubleshooting computing devices, it is noted that these implementations are intended merely as non-limiting examples and are not intended to limit the scope of the description or the claimed subject matter to any specific use case(s) unless explicitly stated otherwise.

As noted above, the quality of answers provided by a RAG system can rely heavily on the content and context of the documents that are provided to an underlying LLM alongside a user query. For instance, queries often lack sufficient context, or retrieved documents for a given query often do not fully align with the query, which can cause the LLM to generate incorrect or irrelevant answers. This can result in mixed responses, where multiple possible answers are combined, or “hallucinations,” which is a term used in the art to refer to a type of incorrect response in which the LLM attempts to generate information outside the provided data. It is desirable to implement techniques to evaluate and correct potential errors in LLM responses, particularly in use cases associated with customer-facing and/or corporate environments in which there are potential risks associated with reduced customer satisfaction, potential legal liability, and/or other factors.

Implementations described herein can address various primary issues that have been identified that can adversely impact the quality of LLM responses in an RAG architecture. These issues can include, but are not limited to, the following:

1) The query lacks sufficient context and is somewhat abstract. An example of such a query is “My laptop is not booting up.” Here, important details, such as the laptop model and/or operating system, are unknown. As a result, the LLM may provide a generic answer instead of one tailored to the specific context.

2) The RAG does not have enough context information to provide an optimal answer. An example of this is a query such as “My network switch is not routing requests correctly,” where the RAG data may not contain the full context. As a result, the LLM may attempt to generate an answer with the limited context available, which may not be fully relevant or accurate.

3) The RAG indicates multiple potential answers. An example of this is a query such as “My operating system is freezing,” where troubleshooting steps differ for each version of the operating system. If the RAG contains troubleshooting steps for multiple operating systems and/or versions, the LLM may provide a mixed or incorrect response by combining information from different operating systems.

To address the above and/or other issues, various implementations described herein can incorporate a pre-context builder using natural language processing (NLP) techniques to handle abstract queries for a given domain, an error degree calculator to assess the potential degree of error in a response through similarity scoring and/or other techniques, and a response builder to ensure the most accurate and optimal response is provided to the user.

By implementing one or more of the above components as will be described herein, various advantages can be realized that can improve the performance of an RAG system and/or address limitations of conventional RAG systems. These advantages can include, but are not limited to, the following. The pre-context builder can address the lack of context expansion by refining vague queries before they reach the retrieval model, reducing the risk of irrelevant retrieval. The pre-context builder can also use intent classification and entity extraction in real time to identify missing details, creating a more personalized approach to clarification before retrieval. This can provide improvements to basic static or rule-based clarification by making the query completion process highly adaptive. Additionally, a context-aware multi-document resolution mechanism can be used to evaluate retrieved documents for potential conflicts, resolving any ambiguities before delivering a response. This can ensure that only the most relevant and coherent response is provided, minimizing the risk of hallucination. Further, the error degree calculator can combine multiple scoring methods into a single metric, providing a comprehensive assessment of response accuracy tailored specifically to RAG-based outputs. Other advantages are also possible.

In addition, it is noted that implementations described herein can provide solutions to technical problems that are inextricably tied to computer systems, such as analyzing and potentially modifying queries provided to an LLM, managing the retrieval of documents from a knowledge base or other document store that could contain large numbers of documents (e.g., on the order of thousands of documents or more), determining the quality of those retrieved documents in relation to a query in real time, or the like, in addition to providing those solutions in a manner that cannot reliably be performed by humans. For instance, due to the speed at which a computer processes data, the amount of data that can be processed by a computer in parallel, the timeframe in which a computer processes data, and/or other factors, it is not possible for a human to conduct and oversee retrieval of documents from a knowledge base or other document store at the timescale in which a typical LLM process is executed.

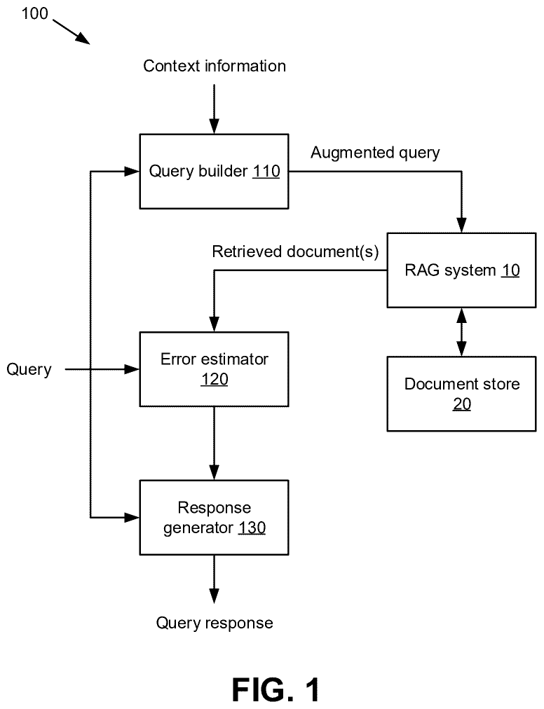

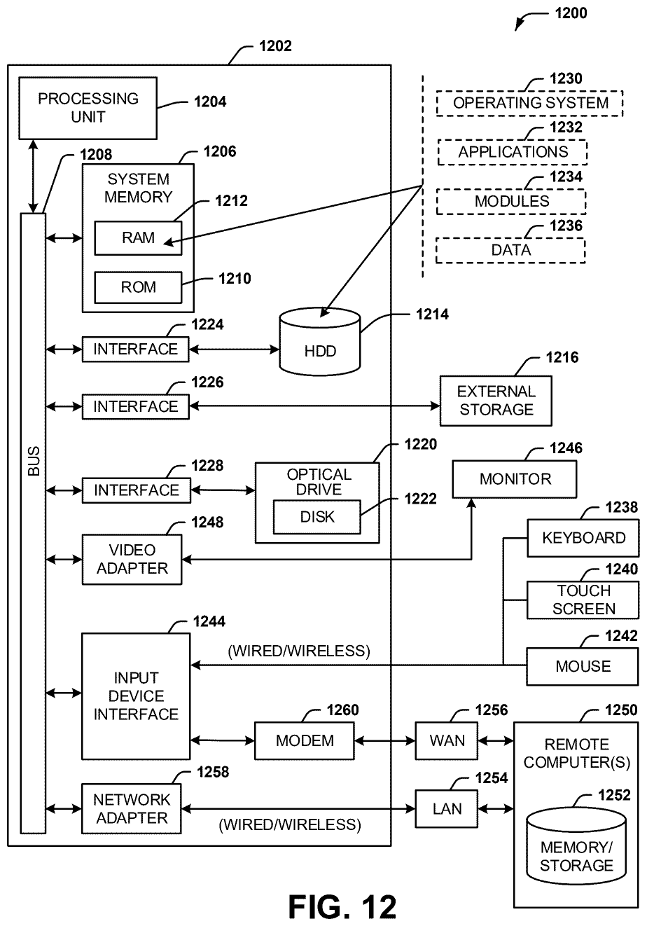

With reference now to the drawings, FIG. 1 illustrates a block diagram of a system 100 that facilitates context-based response formulation for RAG systems in accordance with various implementations described herein. System 100 as shown in FIG. 1 includes executable components, e.g., a query builder 110, an error estimator 120, and a response generator 130, each of which can operate as described in further detail below. In an implementation, the components 110, 120, 130 of system 100 can be implemented in hardware, software, or a combination of hardware and software. By way of example, the components 110, 120, 130 can be stored on at least one memory and executed by at least one processor. An example of a computer architecture including a processor and memory that can be used to implement the components 110, 120, 130, as well as other components as will be described herein, is shown and described in further detail below with respect to FIG. 12. In some implementations, the executable components 110, 120, 130 of system 100, and/or other elements of system 100, can communicate with each other via a bus and/or other components that provide intercommunication between various elements of system 100.

Additionally, it is noted that the functionality of the respective components shown and described herein can be implemented via a single computing device and/or a combination of devices. For instance, in various implementations, the query builder 110 shown in FIG. 1 could be implemented via a first device, the error estimator 120 could be implemented via the first device or a second device, and the response generator 130 could be implemented via the first device, the second device, or a third device. Also, or alternatively, the functionality of a single component could be divided among multiple devices in some implementations.

As will be described in further detail below, the components 110, 120, 130 of system 100 can be utilized to interact with an RAG system 10 to provide responses to user queries based on documents and/or other information sources located in a document store 20. In some implementations, one or more of the components 110, 120, 130 of system 100 can be implemented on the same computing device(s) on which the RAG system 10 and/or or the document store 20 resides. In other implementations, the RAG system 10 and/or document store 20 can be separate from system 100, and the components 110, 120, 130 of system 100 can interact with the RAG system 10 via any suitable wired or wireless communication technology or combination of technologies. In some implementations described herein, the RAG system 10 and/or portions of the response generator 130 can be implemented via an LLM, which, e.g., can be a pre-trained model that operates independently from system 100 such that the components 110, 120, 130 of system 100 do not have direct control over the operation of the LLM outside of the ability to augment queries provided to the LLM and/or to control whether to enable the LLM to generate a response to a given query based on information retrieved by the RAG system 10 as described herein. In other implementations, system 100 as shown in FIG. 1 could be implemented within an LLM itself. Additionally, with respect to the description that follows, it is noted that any specific reference to particular models or model types are provided merely as examples and are not intended to be limiting on the description or the claimed subject matter unless explicitly stated otherwise.

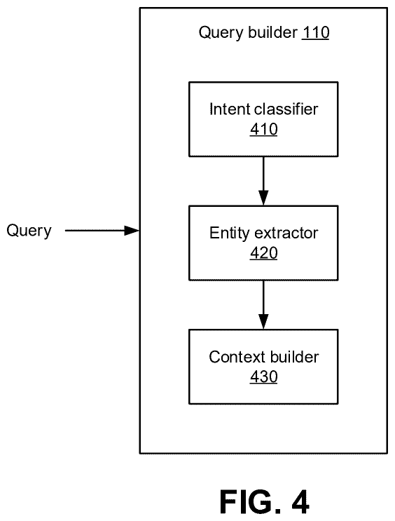

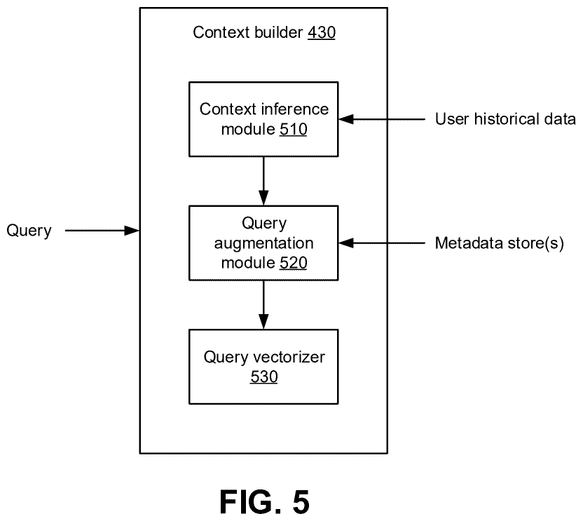

With reference now to the components of system 100, the query builder 110 can augment a query directed to a RAG system 10 with supplemental entity data, resulting in an augmented query that can then be provided to the RAG system 10. The supplemental entity data can be determined by the query builder based on context information associated with the query, expected entity types associated with a determined intent of the query, and/or other suitable factors. Operation of the query builder 110 is described in further detail below with respect to FIGS. 4-5.

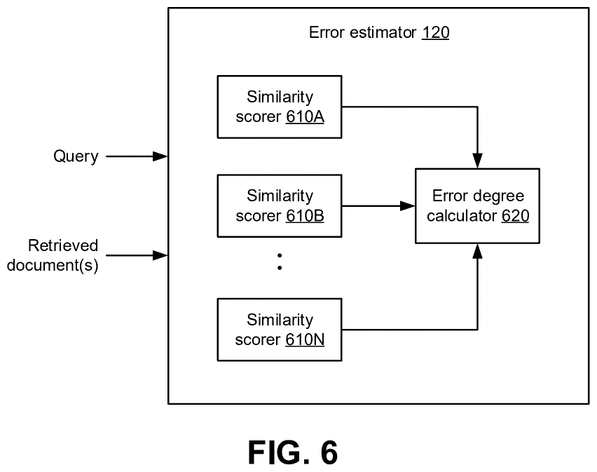

The error estimator 120 of system 100 can estimate a degree of error associated with a document retrieved by the RAG system 10 in response to the augmented query. In an implementation, the error estimator 120 can estimate the degree of error for a given document based on a group of similarity scores, e.g., as described in further detail below with respect to FIG. 6.

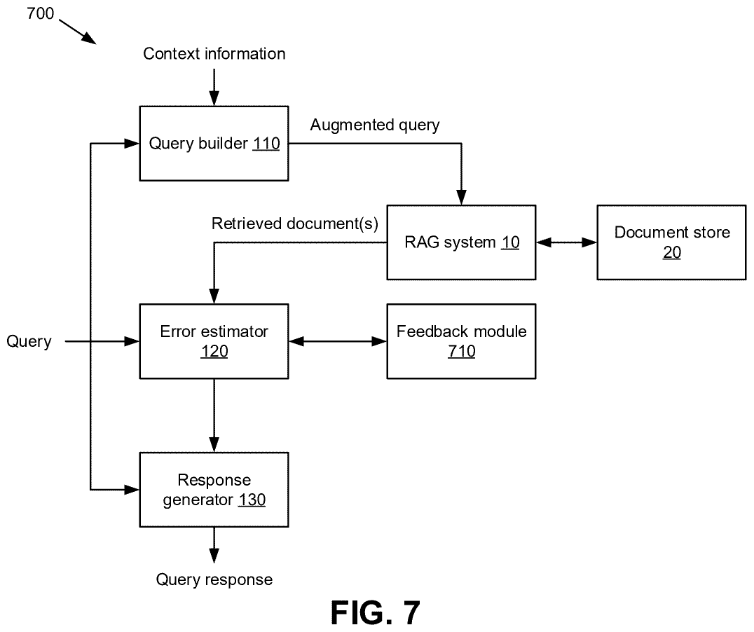

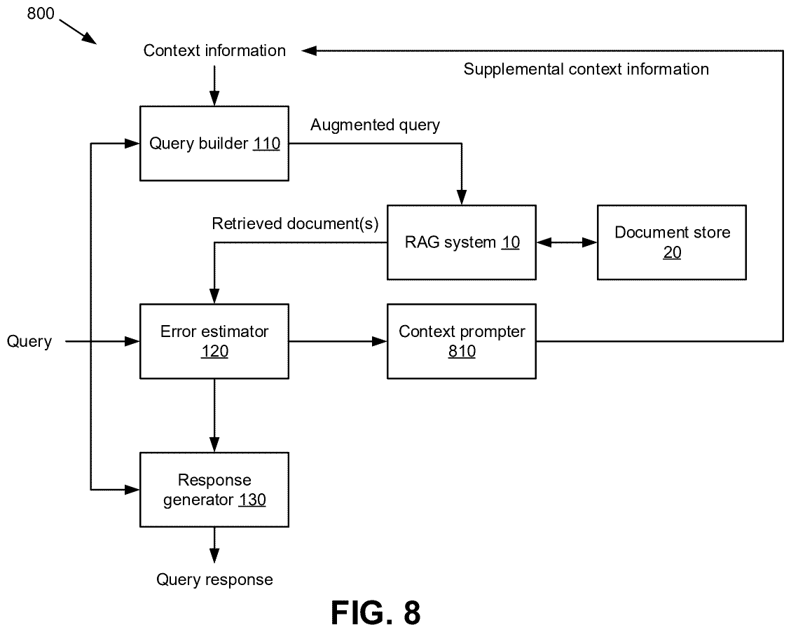

The response generator 130 of system 100 can, in response to the degree of error associated with a retrieved document as estimated by the error estimator 120 being determined to be lower than a threshold degree of error, generate a response to the query based on the retrieved document. In various implementations, the response generator 130 can generate the response itself, or alternatively the response generator 130 can cause another system component, such as an LLM associated with the RAG system 10, to generate the response based on the estimated degree of error of the retrieved document being determined to be suitable for response generation. In the event that the estimated degree of error associated with a retrieved document is higher than the threshold degree of error, one or more alternative actions, such as those described below with respect to FIGS. 7-8, can be taken instead of facilitating generation of a query response via the response generator 130.

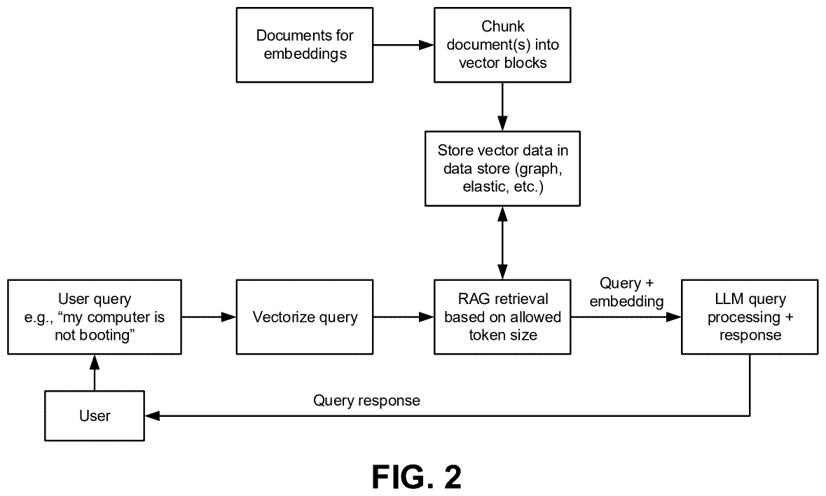

Turning now to FIG. 2, an example RAG infrastructure in which various implementations described herein can operate is illustrated. As shown in FIG. 2, vector embeddings for a group of documents, such as documents associated with a knowledge base and/or another suitable document store, can be generated and stored in a data store (e.g., a document store 20 as shown in FIG. 1). Subsequently, in response to receiving a query from a user, the query can be vectorized and provided to the RAG retrieval system. The RAG retrieval system can then retrieve one or more vector blocks corresponding to one or more documents represented in the data store, e.g., subject to a maximum allowed token size for the retrieved information. Finally, an LLM can generate a response to the query based on the query itself as well as the embedding data retrieved by the RAG retrieval system.

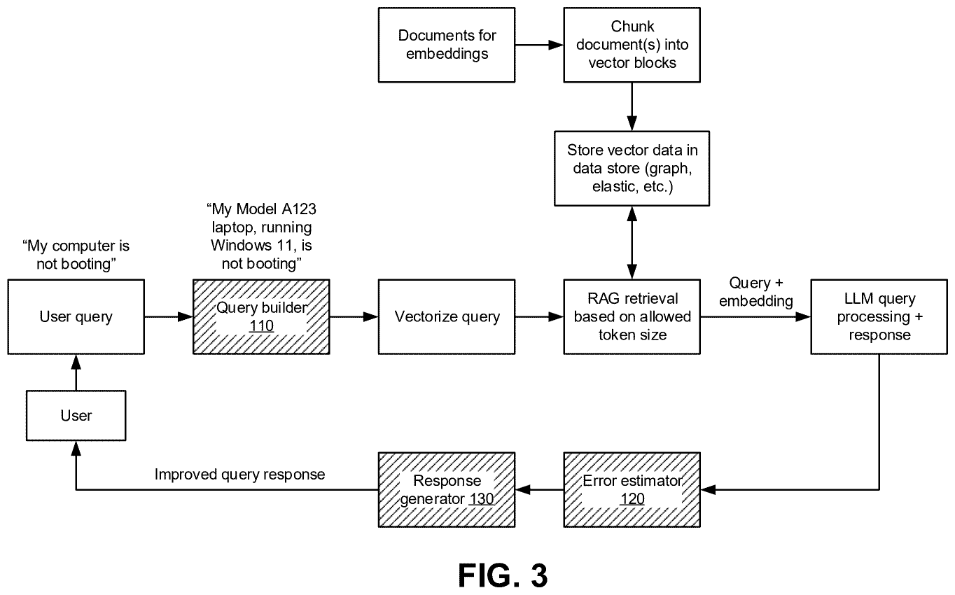

Turning now to FIG. 3, an example enhanced RAG infrastructure is shown, in which the components 110, 120, 130 of system 100 are integrated into the RAG infrastructure of FIG. 2. Incorporation of the components 110, 120, 130 of system 100 into the RAG infrastructure can facilitate enhancement of the accuracy of responses generated by an LLM when utilizing RAG. The components 110, 120, 130 of system 100 as shown in FIG. 3 can also facilitate methods to improve query interpretation and response evaluation, which can be of particular use for corporate troubleshooting scenarios but can be applied to any suitable RAG use case.

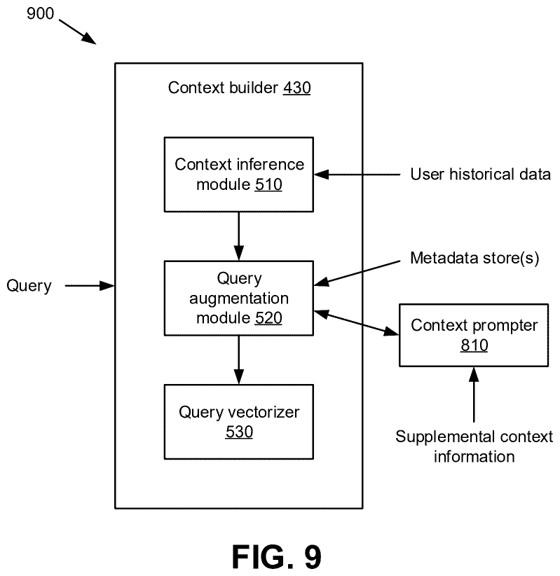

As shown in FIG. 3, the query builder 110 can function as a pre-context builder for query refinement. The query builder 110 can be implemented, e.g., as will be described in further detail below with respect to FIGS. 4-5, as a system that automatically expands abstract user queries by detecting missing contextual information for a given domain using NLP techniques such as intent classification and entity extraction. This can ensure that the LLM receives a fully detailed query to improve retrieval and response generation accuracy. For example, FIG. 3 illustrates a scenario in which a vague user query e.g., “My computer is not booting,” can be expanded by the query builder 110 into a more specific and relevant query, e.g., “My Model A123 laptop, running the Windows 11 operating system, is not booting.” In some implementations, the query builder 110 can use an iterative clarification mechanism (e.g., as described in further detail below with respect to FIGS. 8-9), which can ask targeted questions of a user to gather relevant information before submitting a user query to the RAG system.

As further shown in FIG. 3, the error estimator 120 can function as an error degree calculator for response validation. For instance, the error estimator 120 can employ one or more mechanisms for calculating the likelihood of error in a response to a query generated by a LLM using a weighted combination of multiple similarity scores, e.g., as will be described in further detail below with respect to FIG. 6, that can be computed between the query, its response, and the retrieved documents. The error estimator 120 can employ an error detection process that can provide real-time evaluation of responses, using multiple similarity metrics, to flag potential inaccuracies in generated answers. This can enable the system to detect errors before delivering a response to the user (e.g., via the response generator 130) as well as provide a window to manage the response accurately.

In general, the components 110, 120, 130 of system 100 described above can enhance LLM-based applications by focusing on pre-processing and post-processing techniques that ensure accuracy, reduce ambiguity, and optimize response generation.

With reference now to FIG. 4, various functions that can be performed by the query builder 110 of system 100 are described in further detail. In general, the query builder 110 can be utilized to transform an abstract query directed to an LLM into a more specific query for which an improved response can be generated, e.g., according to a domain in which the LLM operates. To this end, the query builder 110 shown in FIG. 4 includes various subcomponents, such as an intent classifier 410, an entity extractor 420, and a context builder 430, each of which can operate as described below. Similar to the components 110, 120, 130 of system 100 as described above, the subcomponents 410, 420, 430 shown in FIG. 4 can be implemented via hardware, software, or a combination of hardware and software.

The intent classifier 410 of the query builder 110 can identify the main purpose and/or category of a provided query. The intent classifier 410 can use a supervised machine learning (ML) model to classify the query into predefined intent categories, e.g., “Boot Issue,” “Network Issue,” or the like. In one implementation, operation of the intent classifier 410 can be expressed as defining a mapping between a set X={x₁, x₂, . . . , xₙ} of input queries and a set Y={y₁, y₂, . . . , yₘ} of intent classes.

Operation of the intent classifier 410 can begin via a feature representation step, in which each query x₁ can be tokenized and represented as an embedding vector using a pre-trained language model, such as bidirectional encoder representations from transformers (BERT), a generative pre-trained transformer (GPT) model, a term frequency-inverse document frequency (TF-IDF) vectorizer, or the like, as follows:

$${v}_{i} = Embedding ( {x}_{i} ) ,$$

where vᵢ∈R_{d} is the embedding vector in d-dimensional space.

Next, the intent classifier 410 can utilize a classifier that is trained to map the query embedding vi to a probability distribution over the intent classes, which can be expressed as follows:

$${Y}_{i}^{′} = softmax ( {Wv}_{i} + b ) ,$$

where W∈R_{m×d} is the weight matrix, b∈Rₘ is the bias vector, Y′ᵢ is the predicted intent probability distribution, and Yᵢ=arg max Y′ᵢ gives the predicted intent for the query.

Additionally, cross-entropy loss can be used for training the classifier, e.g., according to a loss function such as the following:

$$L = - {\sum }_{i = 1}^{n} {\sum }_{j} = {y}_{ij} log ( {Y}_{i j}^{′} )$$

where yᵢⱼ=1 if query xᵢⱼ belongs to intent class Yⱼ and yᵢⱼ=0 otherwise.

The entity extractor 420 shown in FIG. 4 can identify important entities (e.g., device type, operating system, etc.) from a query. In an implementation, the entity extractor 420 can use a named entity recognition (NER) approach, which can be implemented via conditional random fields (CRF) or a transformer-based model. For example, the entity extractor 420 can be implemented via one or more functions of the open source library spaCy. Other implementations could also be used. In general, the entity extractor 420 can be utilized to extract entities from a query based on the intent of the query as determined via the intent classifier 410. In some implementations, the entity extractor 420 can operate in real time to extract entities from a provided query based on a model that is pre-trained based on expected query intents, e.g., as described below.

Operation of the entity extractor 420 can be defined as extraction of a set of entities Eᵢ={e₁, e₂, . . . , eₖ} for a given query xᵢ, where each element eⱼ in set Eᵢ is a named entity, such as “laptop,” “Windows 10,” or the like. This process can begin via sequence labeling, in which each word and/or token w in a query is labeled with an entity type. This can be framed as a sequence labeling problem, such as the following:

$${e}_{t} = arg {max}_{e ∈ EP} ( {e}_{t} \vert {w}_{t} , {v}_{t} ) ,$$

where er is the entity type (e.g., “Device,” “Operating System,” etc.) and vₜ is the embedding vector for token wₜ.

Next, to model the sequential dependencies between entity tags, the entity extractor 420 can use a CRF layer on top of the token embeddings. For instance, y=(y₁, y₂, . . . , y_{T}) can be defined as the sequence of entity tags for the input sequence w₁, w₂, . . . , w_{T}. Based on this definition, the probability of a given sequence of labels can be expressed as follows:

$$P ( y \vert w ) = \frac{exp ( {\sum }_{t = 1}^{T} ( W {v}_{t} + b ) + {\sum }_{t = 1}^{T - 1} {A}_{{y}_{t} , {y}_{t + 1}} )}{{\sum }_{{y}^{′} ∈ y} exp ( {\sum }_{t = 1}^{T} ( {Wv}_{t} + b ) + {\sum }_{t = 1}^{T - 1} {A}_{{y}_{t}^{′} , {y}_{t + 1}^{′}} )}$$

where A is the transition matrix for entity tags.

In addition, a negative log-likelihood loss function can be used for training the CRF, e.g., L=−log P(y|w).

In an implementation, the entity extractor 420 can utilize the above steps to extract one or more named entities from a query and map those named entities to respective expected entity types associated with an intent of the query. For example, the entity extractor 420 can output the following based on an example query “My laptop is not booting up”:
1) “laptop”->Entity: Device
2) No operating system found->Entity: Missing
3) No model found->Entity: Missing

Turning next to the context builder 430 of the query builder 110, the context builder 430 can enrich a given query with additional context, either by prompting a user for clarification (e.g., as described below with respect to FIGS. 8-9), leveraging historical data, or inferring missing information. An example implementation of the context builder 430 is shown in FIG. 5, which includes subcomponents including a context inference module 510, a query augmentation module 520, and a query vectorizer 530. The functionality of these subcomponents is described in further detail below. In general, the context builder 430 can combine entities Eᵢ, a user history Hᵢ, and knowledge base information Kᵢ to build an enriched query q′ᵢ.

The context inference module 510 shown in FIG. 5 can be utilized to attempt to fill missing entities in a given query using historical information. In an implementation, this historical information can include user history information and/or other historical information associated with a user that provides a query to an LLM associated with the context builder 430. By way of example, the context builder 430 can be associated with a chatbot or other service that accepts queries from users that are logged in to the service with a valid user account and/or are otherwise registered for use of the service. The historical data for such a user can include data associated with the corresponding user account, such as a history of devices the user has purchased over a defined period of time and/or device information relating to those devices, a transaction history of the user for a service provider associated with the service (e.g., with respect to warranty purchases, active service contracts, etc.), and/or other information that can be obtained via the corresponding user account.

For each query provided to the context builder 430, the context inference module 510 can attempt to fill missing entities using historical information, e.g., as described above. This context inference process can be represented as follows:

$${C}_{i} = arg {max}_{c ∈ {H}_{i}} P ( c \vert {E}_{i} , {x}_{i} ) ,$$

where Cᵢ represents the most likely missing context (e.g., device model, operating system, etc.) given the available entities Eᵢ and the query xᵢ. As a specific, non-limiting example, in the absence of other information, a query seeking support for a device that is not specified in the query can be assumed by the context inference module 510 to be the most recent device purchased by the user associated with the query as given by their account information.

After context information has been inferred for a given query, the query augmentation module 520 of the context builder 430 can construct a final augmented query q′ᵢ by combining the original query xᵢ with the inferred context Cᵢ and, optionally, additional metadata Mᵢ. In an implementation, the additional metadata Mᵢ can be obtained via one or more metadata stores, which in some cases can be the same data stores that hold the user historical data utilized by the context inference module 510. For instance, metadata utilized by the query augmentation module 520 can include additional information associated with an account of a user that submits a query to be processed, some of which information may or may not be accessible to the user. Examples of metadata that can be used in the non-limiting use case of a query regarding support for a computing device can include a service tag identifier or other device identifier for the device at issue, a timestamp corresponding to a time at which the device was purchased or otherwise acquired by the user, information relating to versions of an operating system and/or other software features of the device, an identification of a hardware revision of the device (e.g., in the event that a given device has multiple versions), a location (e.g., geographical region, country, state, etc.) in which the device was purchased and/or otherwise acquired, and/or other suitable information.

To restate the above, the query augmentation module 520 can augment a given query, which can contain one or more named entities, with additional named entities that correspond to expected entity types associated with the query. This can be expressed as q′ᵢ=xᵢ+Cᵢ+Mᵢ for an original query xᵢ, inferred context Cᵢ, and metadata Mᵢ.

As further shown in FIG. 5, subsequent to generation of an augmented query, the query vectorizer 530 can then transform the augmented query into a context-aware embedding v′ᵢ, e.g., as follows:

$${v}_{i}^{′} = Embedding ( {q}_{i}^{′} ) .$$

Returning briefly to FIG. 1, even with query augmentation as performed by the query builder 110 as described above, there can still be cases in which the RAG system 10 can provide erroneous responses due to various factors. To mitigate this, the error estimator 120 can determine an estimated degree of error associated with the RAG response. An example implementation of the error estimator 120 is shown by FIG. 6. As FIG. 6 illustrates, the error estimator 120 can determine a group of similarity metrics (e.g., via similarity scorers 610), which can be representative of an extent (amount, degree) of similarity between an augmented query and a document retrieved by the RAG system 10 as shown in FIG. 1. The error estimator 120 can then, via an error degree calculator 620, synthesize the similarity metrics to determine a degree of error associated with the retrieved document, e.g., as a function of a weighted sum of the group of similarity metrics, and/or by other means.

While N similarity scorers 610A-610N are shown in FIG. 6, it is noted that the numbering convention utilized for the similarity scorers are not intended to imply any specific number of similarity scorers 610, as the error estimator 120 could use any suitable number of similarity scorers 610, including one similarity scorer 610 or multiple similarity scorers 610. In addition, while the following description relates to specific similarity metrics that can be utilized by the error estimator 120, it is noted that these similarity metrics are provided merely by way of example and are not intended to be limiting on the similarity metrics that could be utilized by the error estimator 120.

In a non-limiting example implementation of the error estimator 120, degree of error can be represented as a composite score that combines three primary metrics: ROUGE (recall-oriented understudy for gisting evaluation) score, which measures the overlap between a generated response and the relevant content retrieved from associated documents; cosine similarity, which measures how close the user query and response embeddings are to the retrieved document; and semantic similarity, which measures the alignment of meanings between the generated response and the content in the documents. These metrics are described in further detail below.

### ROUGE Score

A ROUGE score measures the overlap between a retrieved document d and an associated response r, e.g., by comparing the n-grams (word sequences) between these two texts. A higher ROUGE score indicates more overlap, while lower scores suggest less relevance.

ROUGE scores can be generalized to ROUGE-n, which measures the overlap of n-grams (e.g., unigrams, bigrams, etc.), as follows:

$$ROUGE - n ( d , r ) = \frac{{\sum }_{n ∈ d n r} Count ( n )}{{\sum }_{n ∈ d} Count ( n )}$$

where d is the relevant document retrieved, r is the generated response, and n represents n-grams. For example, ROUGE-1 measures unigrams, ROUGE-2 measures bigrams, and so on.

### Cosine Similarity (Between Query and Response)

Cosine similarity measures the similarity between two vectors by calculating the cosine of the angle between them. This can be used to measure the similarity between a query q and a generated response r, as well as between a query and a retrieved document.

Given the embeddings of a query and its response, cosine similarity can be defined as follows:

$$Cosine Similarity ( {v}_{q} , {v}_{r} ) = \frac{{v}_{q} - {v}_{r}}{‖ {v}_{q} - {v}_{r} ‖}$$

where v_{q} is the embedding vector of the query and vᵣ is the embedding vector of the response. If the cosine similarity is high (e.g., close to 1), the response is semantically similar to the query. If it is low (e.g., closer to 0), there is likely a mismatch.

### Semantic Similarity

Semantic similarity captures the deeper meaning of a query and its response as well as any associated document content. This can be computed using models such as BERT, which evaluate the contextual similarity between sentences. Semantic similarity can compare the embeddings of both sentences and documents. Given a query embedding vector v_{q} and a response embedding vector vᵣ, semantic similarity can be expressed as follows:

$$Semantic Similarity ( {v}_{q} , {v}_{r} ) = \frac{{v}_{q} \cdot {v}_{r}}{‖ {v}_{q} ‖ ‖ {v}_{r} ‖}$$

### Degree of Error Calculation

Based on the above and/or other suitable metrics, the degree of error can be computed as a function of a weighted sum of the similarity score components. Respective weights, e.g., w₁, w₂, w₃, etc., can be assigned to each metric based on its importance. In various implementations, the weights applied to respective similarity metrics can be set based on the LLM utilized by the RAG system (e.g., as different models construct responses differently and operate according to different definitions of similarity) and/or other suitable factors. In some implementations, the weights can also be configured such that they are decimal values that sum to 1.

Based on the above, a formula that can be utilized by the error estimator 120 for computing a degree of error (DoE) is as follows:

$$DoE ( q , r , d ) = \begin{matrix}{w}_{1} \cdot ( 1 - ROUGE - n ( d , r ) ) + \\ {w}_{2} \cdot ( 1 - Cosine Similarity ( {v}_{q} , {v}_{r} ) ) + \\ {w}_{3} \cdot ( 1 - Semantic Similarity ( {v}_{q} , {v}_{r} ) )\end{matrix}$$

The degree of error, as computed above, represents the deviation from an optimal response. Thus, a higher degree of error indicates a higher likelihood of error in the response.

As an example degree of error calculation, the following hypothetical scenario is considered:

Query: “My laptop is not booting up.”

Retrieved document: Contains troubleshooting steps for various OS types.

Generated response: Generic boot-up troubleshooting.

Based on the above, the following similarity metrics can be computed:
ROUGE-1 score: 0.7
Cosine similarity between query and response: 0.8
Semantic similarity between document and response: 0.9

For weighting definitions of w₁=0.4, w₂=0.3, w₃=0.3, the degree of error can be computed as DoE=0.12+0.06+0.03=0.21. Here, a degree of error of 0.21 indicates a moderate error in the generated response. Lower values indicate better accuracy, while higher values suggest more significant deviations or errors.

Turning next to FIG. 7, a block diagram of another system 700 that facilitates context-based response formulation for RAG systems is illustrated. Repetitive description of like parts described above with regard to other implementations is omitted for brevity. System 700 as shown in FIG. 7 includes a query builder 110, an error estimator 120, and a response generator 130 that can operate as described above. In addition, system 700 includes a feedback module 710 that can be utilized, e.g., during testing of system 100, to provide feedback regarding the operation of system 700 for designated queries.

In an implementation, a threshold T can be defined for acceptable errors, e.g., based on the LLM utilized by system 700, a desired tradeoff between response accuracy and system performance, and/or other factors. As queries are processed by system 700, the feedback module 710 can collect information relating to the degree of error computed by the error estimator 120 for respective queries. This can assist a developer of system 700 in setting an appropriate degree of error threshold during initial system setup, e.g., by enabling a developer to manually compare a degree of error computed by the error estimator 120 to a corresponding response generated by system 700. Subsequent to the initial system setup as described above, the feedback module 710 can be used to fine tune the performance of system 700, e.g., by flagging responses having a degree of error over the defined threshold for review.

With reference now to FIG. 8, a block diagram of still another system 800 that facilitates context-based response formulation for RAG systems is illustrated includes a context prompter 810 that can facilitate obtaining additional context information from a user, e.g., in the event that a degree of error computed by the error estimator 120 exceeds the threshold degree of error. By way of example, in response to the degree of error associated with a response to a query, or a document retrieved in response to a query, being determined to be higher than the threshold degree of error, the context prompter 810 can prompt a user associated with the query for additional context information, e.g., by asking clarifying questions to the user, or via other approaches, instead of generating a potentially erroneous response via the response generator 130.

In an implementation, responses to clarifying questions asked by the context prompter 810 can be utilized by the query builder 110 to supplement a previously augmented query with additional context information, resulting in a new augmented query. The error estimator 120 can then determine the degree of error associated with the new augmented query, and the context prompter 810 can facilitate asking additional clarifying questions, until the degree of the error of the new augmented query is determined to have decreased below the threshold degree of error. At that time, the generated response to the new augmented query can be generated via the response generator 130.

System 900 in FIG. 9 illustrates another example implementation of the context prompter 810 in connection with the context builder 430 described above with respect to FIG. 5. Here, the query augmentation module 520 can determine whether a given query contains named entities corresponding to all of the expected entity types associated with the query, e.g., based on the determined intent of the query as described above with respect to FIG. 4. In response to determining that the named entities in the query correspond to less than all of the expected entity types, the context prompter 810 can prompt a user associated with the query to provide additional information corresponding to the missing named entities. The query augmentation can then include this additional information into the augmented query, and the augmented query can proceed to vectorization as described above.

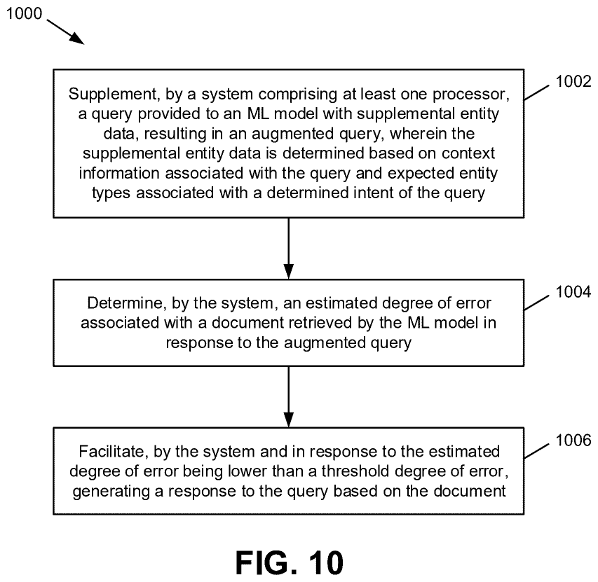

Referring now to FIG. 10, a flow diagram of a method 1000 that facilitates context-based response formulation for RAG systems is illustrated. At 1002, a system comprising at least one processor can supplement (e.g., by a query builder 110) a query provided to an ML model (e.g., a ML model associated with an RAG system 10) with supplemental entity data, resulting in an augmented query. The supplemental entity data can be determined based on context information associated with the query and expected entity types associated with a determined intent of the query.

At 1004, the system can determine (e.g., by an error estimator 120) an estimated degree of error associated with a document retrieved by the ML model (e.g., from a document store 20) in response to the augmented query.

At 1006, the system can facilitate (e.g., by a response generator 130), in response to the estimated degree of error determined at 1004 being lower than a threshold degree of error, generating a response to the query based on the document.

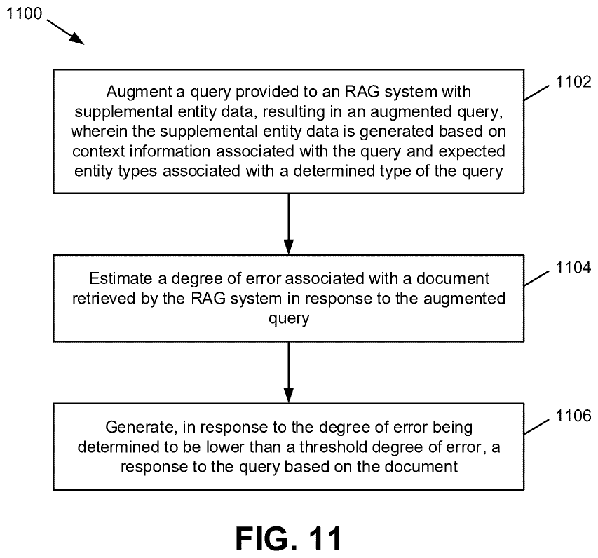

Referring next to FIG. 11, a flow diagram of a method 1100 that can be performed by at least one processor, e.g., based on machine-executable instructions stored on a non-transitory machine-readable medium, is illustrated. An example of a computer architecture, including a processor and non-transitory media, that can be utilized to implement method 1100 is described below with respect to FIG. 12.

Method 1100 can begin at 1102, in which the at least one processor can augment a query provided to an RAG system with supplemental entity data, resulting in an augmented query, wherein the supplemental entity data is generated based on context information associated with the query and expected entity types associated with a determined type of the query.

At 1104, the at least one processor can estimate a degree of error associated with a document retrieved by the RAG system in response to the augmented query.

At 1106, in response to the degree of error being determined to be lower than a threshold degree of error, the at least one processor can generate a response to the query based on the document.

FIGS. 10-11 as described above illustrate methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

In order to provide additional context for various embodiments described herein, FIG. 12 and the following discussion are intended to provide a brief, general description of a suitable computing environment 1200 in which the various embodiments of the embodiment described herein can be implemented. While implementations have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IOT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference now to FIG. 12, an example general-purpose environment 1200 for implementing various embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD), a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

1. A system, comprising:
at least one processor; and
at least one memory that stores executable instructions that, when executed by the at least one processor, facilitate performance of operations, the operations comprising:
adjusting, based on first degrees of error computed for first queries directed to a retrieval-augmented generation system, a threshold degree of error associated with the retrieval-augmented generation system, resulting in an adjusted threshold degree of error;
augmenting a second query directed to the retrieval-augmented generation system with supplemental entity data, resulting in an augmented query, wherein the supplemental entity data is determined based on context information associated with the second query and expected entity types associated with a determined intent of the second query;
estimating a second degree of error associated with a document retrieved by the retrieval-augmented generation system in response to the augmented query; and
in response to the second degree of error associated with the document being determined to be lower than the adjusted threshold degree of error, generating a response to the second query based on the document.

2. The system of claim 1, wherein the context information is first context information, and wherein the operations further comprise:
in response to the second degree of error associated with the document being determined to be higher than the adjusted threshold degree of error, prompting a user associated with the second query for second context information, associated with the expected entity types, instead of the generating of the response to the second query.

3. The system of claim 2, wherein the augmented query is a first augmented query, wherein the document is a first document, and wherein the operations further comprise:
supplementing the augmented query with the second context information, resulting in a second augmented query;
estimating a third degree of error associated with a second document retrieved by the retrieval-augmented generation system in response to the second augmented query; and
in response to the third degree of error being determined to be higher than the adjusted threshold degree of error, repeating the prompting, the supplementing, and the estimating of the third degree of error.

4. The system of claim 1, wherein the context information comprises user history information corresponding to a user associated with the second query.

5. The system of claim 4, wherein the second query relates to a computing device, and wherein the context information comprises device information relating to the computing device as present in the user history information.

6. The system of claim 5, wherein the device information is of a type selected from a group of types comprising a device model identifier type, a hardware revision identifier type, and a software version identifier type.

7. The system of claim 1, wherein the estimating of the second degree of error comprises:
determining a group of similarity metrics representative of an extent of similarity between the augmented query and the document; and
determining the second degree of error as a function of a weighted sum of the group of similarity metrics.

8. The system of claim 1, wherein the augmenting comprises:
extracting one or more first named entities from the second query;
mapping the one or more first named entities to first ones of the expected entity types; and
selecting, as the supplemental entity data, one or more second named entities corresponding to second ones of the expected entity types.

9. The system of claim 8, wherein the operations further comprise:
in response to determining that the one or more first named entities and the one or more second named entities correspond to less than all of the expected entity types, prompting a user associated with the second query for third named entities corresponding to other ones of the expected entity types, other than the first ones and the second ones.

10. A method, comprising:
facilitating, by a system comprising at least one processor, adjusting a threshold degree of error associated with a machine learning model based on estimated first degrees of error computed for first queries provided to the machine learning model, resulting in an adjusted threshold degree of error;
supplementing, by the system, a second query provided to the machine learning model with supplemental entity data, resulting in an augmented query, wherein the supplemental entity data is determined based on context information associated with the second query and expected entity types associated with a determined intent of the second query;
determining, by the system, a second estimated degree of error associated with a document retrieved by the machine learning model in response to the augmented query; and
facilitating, by the system and in response to the second estimated degree of error being lower than the adjusted threshold degree of error, generating a response to the second query based on the document.

11. The method of claim 10, wherein the context information is first context information, and wherein the method further comprises:
prompting, by the system and in response to the second estimated degree of error being higher than the adjusted threshold degree of error, a user associated with the second query for second context information, associated with the expected entity types, instead of the facilitating of the generating of the response to the second query.

12. The method of claim 10, wherein the context information comprises historical information corresponding to a user associated with the second query.

13. The method of claim 12, wherein the second query relates to a computing device, and wherein the context information comprises device information relating to the computing device as present in the historical information.

14. The method of claim 10, wherein the determining of the second estimated degree of error comprises:
determining respective similarity metrics, representative of a degree of similarity between the augmented query and the document; and
determining the second estimated degree of error as a function of a weighted sum of the respective similarity metrics.

15. The method of claim 10, wherein the supplementing comprises:
extracting one or more first named entities from the second query;
mapping the one or more first named entities to first ones of the expected entity types; and
selecting, as the supplemental entity data, one or more second named entities corresponding to second ones of the expected entity types.

16. A non-transitory machine-readable medium comprising computer executable instructions that, when executed by at least one processor, facilitate performance of operations, the operations comprising:
adjusting a threshold degree of error associated with a retrieval-augmented generation system based on first degrees of error computed for first queries provided to the retrieval-augmented generation system, resulting in an adjusted threshold degree of error;
augmenting a second query provided to the retrieval-augmented generation system with supplemental entity data, resulting in an augmented query, wherein the supplemental entity data is generated based on context information associated with the second query and expected entity types associated with a determined type of the second query;
estimating a second degree of error associated with a document retrieved by the retrieval-augmented generation system in response to the augmented query; and
generating, in response to the second degree of error being determined to be lower than the adjusted threshold degree of error, a response to the second query based on the document.

17. The non-transitory machine-readable medium of claim 16, wherein the context information is first context information, and wherein the operations further comprise:
prompting, in response to the second degree of error being determined to be higher than the adjusted threshold degree of error, a user associated with the second query for second context information, associated with the expected entity types, instead of generating the response to the second query.

18. The non-transitory machine-readable medium of claim 16, wherein the context information comprises historical information corresponding to a user associated with the second query.

19. The non-transitory machine-readable medium of claim 16, wherein the estimating of the second degree of error comprises:
determining respective similarity metrics, representative of an amount of similarity between the augmented query and the document; and
estimating the second degree of error as a function of a weighted sum of the respective similarity metrics.

20. The non-transitory machine-readable medium of claim 16, wherein the augmenting comprises:
extracting one or more first named entities from the second query;
mapping the one or more first named entities to first ones of the expected entity types; and
selecting, as the supplemental entity data, one or more second named entities corresponding to second ones of the expected entity types.
